(19) United States
(12) Patent Application Publication
(10) Pub. No.: US 2013/0277601 A1
(43) Pub. Date: Oct. 24, 2013

(54) COMPOSITE, SOFT-MAGNETIC POWDER AND ITS PRODUCTION METHOD, AND DUST CORE FORMED THEREBY

(71) Applicants: Fumi Kurita, Mishima-gun (JP); Hisato Tokoro, Mishima-gun (JP)

(72) Inventors: Fumi Kurita, Mishima-gun (JP); Hisato Tokoro, Mishima-gun (JP)

(73) Assignee: HITACHI METALS, LTD., Minato-ku, Tokyo (JP)

(21) Appl. No.: 13/978,027

(22) PCT Filed: Mar. 6, 2012
(86) PCT No.: PCT/JP2012/055657

§ 371 Date: Jul. 2, 2013

(30) Foreign Application Priority Data
Mar. 28, 2011 (JP) 2011/057622

(51) Int. Cl. H01F 1/01; H01F 41/00

(52) U.S. Cl. CPC H01F 1/01; H01F 41/005
USPC 252/62.55; 427/215; 427/216; 335/297

(57) ABSTRACT

A composite, soft-magnetic powder comprising soft-magnetic, iron-based core particles having an average particle size of 2-100 μm, and boron nitride-based coating layers each covering at least part of each soft-magnetic, iron-based core particle, said coating layers being polycrystalline layers comprising fine boron nitride crystal grains having different crystal orientations and an average crystal grain size of 3-15 nm, the average thickness of said polycrystalline layers being 6.6% or less of the average particle size of said soft-magnetic, iron-based core particles, is produced by (1) mixing iron nitride powder having an average particle size of 2-100 μm with boron powder having an average particle size of 0.1-10 μm, (2) heat-treating the resultant mixed powder at a temperature of 600-850° C. in a nitrogen atmosphere, and (3) removing non-magnetic components.

### FIELD OF THE INVENTION

The present invention relates to a composite, soft-magnetic powder in which each particle has a boron nitride-based coating layer, and its production method, and a dust core formed thereby.

### BACKGROUND OF THE INVENTION

Size reduction and frequency increase have recently been advancing in electric/electronic parts made of soft-magnetic materials, such as reactors, inductors, choke coils, motor cores, etc., requiring soft-magnetic materials having smaller losses in high-frequency ranges, larger saturation magnetization, and better DC superimposition characteristics (less decrease in inductance by current increase when DC bias current flows) than those of conventionally used magnetic steel, soft ferrite, etc. Powders of such soft-magnetic materials are suitable for dust cores for electric/electronic parts, and to suppress the generation of eddy current, a main cause of loss in high-frequency ranges, various soft-magnetic powders with insulating layers on metal particles and their production methods have been proposed.

JP 2004-259807 A discloses a magnetic powder for dust cores comprising metal particles having an average particle size of 0.001-1 μm, which are mainly obtained by reducing metal oxides, the metal particles being covered with carbon or boron nitride. However, because this magnetic powder has a small average particle size of 0.001-1 μm, the insulating coatings have a relatively large volume ratio, resulting in a small density of less than 6.0 Mg/m³. Accordingly, dust cores formed by this magnetic powder do not have high permeability and high saturation magnetization.

JP 2010-236021 A discloses a method for producing a dust core comprising the steps of coating pure iron powder in which each particle has a surface oxide layer with a solution of boron or its compound, compression-molding the soft-magnetic powder, heat-treating the resultant green body at 500° C. in a nitrogen gas atmosphere to convert the coating of boron or its compound to a boron nitride coating, and then removing strain by elevating the heat treatment temperature to 1000° C. Because pure iron powder coated with boron or its compound is compression-molded in this method, the coating layers are easily peeled during compression molding, resulting in insufficient insulation between pure iron particles. As a result, dust cores obtained by this method have large loss. In this method, boron or its compound is nitrided after compression molding, but nitriding increases the volumes of coating layers, resulting in lower space factors of magnetic components. In addition, byproducts and unreacted components in the nitriding reaction cannot be removed. As a result, dust cores obtained by this method have not only low density but also low permeability.

JP 2005-200286 A and “Journal of Electron Microscopy,” 55(3), 123-127 (2006) disclose the formation of nano-particles comprising Fe core particles and hexagonal boron nitride (h-BN) coating layers by mixing Fe₄N powder and B powder at a weight ratio of 1/1, and heat-treating the resultant mixture at 1000° C. in a nitrogen gas atmosphere. They describe that BN-coated Fe nano-capsules are formed mainly when the Fe nano-particles are as small as less than 20 nm, and that BN nanotubes having bamboo-like structures, which hold Fe nano-particles, are formed when the Fe nano-particles are as large as more than 100 nm. However, because the heat treatment temperatures are as high as 1000° C. in these references, too thick BN layers which are easily broken during compression molding are formed, resulting in a small volume ratio of iron, and thus failing to obtain dust cores with low loss.

### OBJECT OF THE INVENTION

Accordingly, an object of the present invention is to provide a composite, soft-magnetic powder having a high density, high saturation magnetization and good lubrication, and its production method, and a low-loss dust core formed by such a composite, soft-magnetic powder, which has high permeability and excellent DC superimposition characteristics.

### SUMMARY OF THE INVENTION

The composite, soft-magnetic powder of the present invention comprises soft-magnetic, iron-based core particles having an average particle size of 2-100 μm, and boron nitride-based coating layers each covering at least part of each soft-magnetic, iron-based core particle, said coating layers being polycrystalline layers comprising fine boron nitride crystal grains having different crystal orientations and an average crystal grain size of 3-15 nm, the average thickness of said polycrystalline layers being 6.6% or less of the average particle size of said soft-magnetic, iron-based core particles.

Said soft-magnetic, iron-based core particles are preferably made of pure iron or an iron-based alloy. In said composite, soft-magnetic powder, the ratio of Fe on the outermost surface is preferably 12 atomic % or less. The core particles are preferably covered with the boron nitride-based layers entirely, though their covering may be partial. In the former case, of course, the ratio of Fe on the outermost surface is 0 atomic %. In the latter case, when the ratio of Fe on the outermost surface is 12 atomic % or less in the composite, soft-magnetic powder, the coating layers can sufficiently function as insulating layers in the resultant dust cores, suppressing eddy current loss. “The ratio of Fe on the outermost surface” means the ratio of Fe per the total amount of boron, nitrogen, oxygen and iron on the outermost surface, iron being not limited to pure iron but including Fe in the form of any compound (for example, oxide).

In the composite, soft-magnetic powder of the present invention, the volume ratio of iron is preferably 70% or more. The above thickness and structure of the boron nitride-based coating layers make the percentage of the soft-magnetic, iron-based core particles high, resulting in high permeability and high magnetization.

The method for producing the above composite, soft-magnetic powder comprises the steps of (1) mixing iron nitride powder having an average particle size of 2-100 μm with boron powder having an average particle size of 0.1-10 μm, (2) heat-treating the resultant mixed powder at a temperature of 600-850° C. in a nitrogen atmosphere, and (3) removing non-magnetic components.

The atomic ratio of said iron nitride powder to said boron powder is preferably B/Fe≧0.03.

The heat treatment temperature is preferably 650-800° C., more preferably 700-800° C.

The dust core of the present invention is formed by the above composite, soft-magnetic powder. The dust core according to a preferred embodiment of the present invention has a density of 5-7 Mg/m³, and core loss of 528 kW/m³ or less (measured at a frequency of 50 kHz and an exciting magnetic flux density of 50 mT), the change rate of said core loss per density change [(kW/m³)/(Mg/m³)] being −96 or more. The core loss is preferably 260 kW/m³ or less, more preferably 220 kW/m³ or less. The change rate of core loss is preferably −75 or more, more preferably −70 or more. Boron nitride having a solid lubrication function can provide a dust core with high density while suppressing strain by molding. Because of small strain, it can suppress hysteresis loss, resulting in a small change rate of core loss per density change.

### BRIEF DESCRIPTION OF THE DRAWINGS

FIG. 1 is a TEM photograph showing a cross section of the composite, soft-magnetic powder of Example 1.

FIG. 2(a) is a TEM photograph showing a cross section of the coating layer in the composite, soft-magnetic powder of Example 1.

FIG. 2(b) is a schematic view showing a crystal structure of the coating layer of FIG. 2(a).

FIG. 3 is a graph showing the relation between the incremental permeabilities of the dust cores of Example 1 and Comparative Example 1 and a DC bias magnetic field.

FIG. 4 is a graph showing the relation between the incremental permeabilities oft dust cores of Example 2 and Comparative Example 2 and a DC bias magnetic field.

FIG. 5 is a graph showing the relation between the incremental permeabilities of the dust cores of Examples 1, 4 and 5 and Comparative Examples 5 and 6 and a DC bias magnetic field.

FIG. 6 is a graph showing the relation between the volume ratio of iron and a heat treatment temperature in the composite, soft-magnetic powders of Examples 1, 4 and 5 and Comparative Examples 5 and 6.

FIG. 7 is a graph showing the relation between coercivity and a heat treatment temperature in the dust cores of Examples 1, 4 and 5 and Comparative Examples 5 and 6.

FIG. 8 is a graph showing the relation between loss and a heat treatment temperature in the dust cores of Examples 1, 4 and 5 and Comparative Examples 5 and 6.

FIG. 9 is a TEM photograph showing a cross section of the core particle of the composite, soft-magnetic powder of Comparative Example 5.

FIG. 10 is a graph showing the relation between the incremental permeabilities of the dust cores of Examples 6-8 and a DC bias magnetic field.

FIG. 11 is a graph showing the relation between loss and density in the dust cores of Examples 9-11 and Comparative Examples 8-10.

FIG. 12 is a graph showing the relation between XRD intensity and a heat treatment temperature in the composite, soft-magnetic powder obtained in Example 12.

FIG. 13 is a graph showing the relation between an XRD chart and a heat treatment temperature in the composite, soft-magnetic powder obtained in Comparative Example 11.

FIG. 14 is a TEM photograph (magnification: 1,000,000 times) showing a boron nitride coating layer of the composite, soft-magnetic powder obtained in Comparative Example 12.

FIG. 15 is a schematic view showing the boron nitride coating layer of FIG. 14.

### DESCRIPTION OF THE PREFERRED EMBODIMENTS

[1] Composite, Soft-Magnetic Powder

(1) Soft-Magnetic, Iron-Based Core Particles

The soft-magnetic, iron-based core particles are preferably made of pure iron or an iron-based alloy. Though pure iron is optimum to obtain high saturation magnetization, an Fe—Si alloy containing 1% or more by mass of Si is preferable to have low loss. However, a larger Si content makes core particles resistant to plastic deformation, resulting in poorer moldability to dust cores. Accordingly, the upper limit of the Si content is preferably 8% by mass. The more preferred Si content is 2-7% by mass. Other than Si, Ni and/or Al may be contained, and for example, Fe—Si—Al alloys and Fe—Ni alloys may be used.

The volume ratio of pure iron or an iron alloy constituting the soft-magnetic, iron-based core particles is preferably 70% or more. The “pure iron or an iron alloy” may be called simply “iron” hereinafter. When the volume ratio of iron is less than 70%, the resultant dust core does not have sufficient permeability. The more preferred volume ratio is 80-95%. The volume ratio of more than 95% provides too thin a boron nitride coating layer, failing to provide the dust core with sufficient insulation. The volume ratio VR of iron is determined from the saturation magnetization Bs of a composite, soft-magnetic powder measured by a vibrating sample magnetometer (VSM) with a magnetic field of 10 kOe applied, by the following formulae:

Bs/Bs1=V1×ρ1/(V1×ρ1+V2×ρ2), and

VR=[V1/(V1+V2)]×100(%),
wherein Bs is the saturation magnetization of the composite, soft-magnetic powder,
Bs1 is the saturation magnetization of iron,
V1 is the volume of iron,
V2 is the volume of boron nitride,
ρ1 is the density of iron, and
ρ2 is the density of boron nitride.

(2) Average Particle Size and Particle Size Distribution

The average particle size D of the composite, soft-magnetic powder is 2-100 μm. The average particle size D is expressed by d50 measured by a laser-diffraction-type, scattering particle size distribution analyzer. When the average particle size is less than 2 μm, a composite, soft-magnetic powder provided with an insulating layer has too low a volume ratio of iron, providing the composite, soft-magnetic powder with low saturation magnetization, and such low flowability that it cannot be easily handled in compression-molding. On the other hand, when the average particle size is more than 100 μm, eddy current loss cannot be fully suppressed in medium and high frequency ranges. The average particle size of the composite, soft-magnetic powder is preferably 2-80 μm, more preferably 2-50 μm, most preferably 2-40 μm.

A coefficient of variation Cv, which expresses a width of the particle size distribution of the composite, soft-magnetic powder of the present invention, is preferably 30-70%, more preferably 40-60%. Here, Cv=(σ/D)×100(%), wherein σ is the standard deviation of the particle size distribution of the composite, soft-magnetic powder, and D is the average particle size of the composite, soft-magnetic powder. When the coefficient of variation Cv is outside the range of 30-70%, gaps tend to be generated between compression-molded core particles, failing to provide a green body with a sufficient density.

(3) Coating Layers

Because the coating layer is a polycrystalline substance comprising fine boron nitride crystal grains with different crystal orientations having an average crystal grain size of 3-15 nm, it exhibits excellent lubrication during molding. Thus, the coating layer can follow the deformation of a core particle during compression molding, providing the dust core with sufficient insulation. When the average crystal grain size is less than 3 nm, the coating layer does not have sufficient lubrication. On the other hand, the average crystal grain size of more than 15 nm does not provide sufficient polycrystalline effects, making it likely that the coating layer is broken during compression molding. The average crystal grain size is preferably 3-12 nm. The average crystal grain size of fine boron nitride crystal grains is determined by measuring the sizes of fine crystal grains, which cross each of plural arbitrary lines perpendicular to each other in a TEM photograph showing a coating layer cross section, and averaging the measured sizes by all fine crystal grains. The number of fine crystals averaged is 20 or more.

The average thickness T_{A} of the coating layers is 6.6% or less, preferably 0.5-6.6%, more preferably 1-6.5%, of the average particle size D_{A} of the soft-magnetic, iron-based core particles. When T_{A} is more than 6.6% of D_{A}, the volume ratio of the soft-magnetic, iron-based core particles is low, providing the composite, soft-magnetic powder with low saturation magnetization. When T_{A} is smaller than 0.5% of D_{A}, the dust core does not have sufficient insulation. T_{A}/D_{A} is determined from the volume ratio VR of iron by the formula of T_{A}/D_{A}=(1−VR^{1/3})/2VR^{1/3}, assuming that the soft-magnetic, iron-based core particles are spherical particles having an average particle size D_{A}, and that they have uniform coating layers having an average thickness T_{A}.

(4) Ratio of Fe on Outermost Surface

In the composite, soft-magnetic powder of the present invention, a coating layer does not necessarily cover each core particle completely, but each boron nitride coating layer is actually not uniform, partially not covering the core particle. The covering ratio of the boron nitride layer is expressed by the ratio of Fe on the outermost surface. In the composite, soft-magnetic powder of the present invention, the ratio of Fe on the outermost surface is preferably 12 atomic % or less. When the ratio of Fe on the outermost surface is more than 12%, too much portions of the cores are exposed without being covered with boron nitride, failing to provide sufficient insulation. The ratio of Fe on the outermost surface is determined by X-ray photoelectron spectroscopy (XPS). A sample is irradiated with monochrome X-rays in ultrahigh vacuum by XPS, and the emitted photoelectron energy is measured to analyze the element composition of the sample on the outermost surface. Specifically, the quantitative analysis of boron, nitrogen, oxygen and iron is conducted by narrow spectrum measurement, to determine the ratio of Fe on the outermost surface. Because the XPS analysis depth is 5 nm, the “outermost surface” means a surface region up to the depth of 5 nm.

[2] Production Method of Composite, Soft-Magnetic Powder

(1) Starting Material Powder

(a) Iron Nitride Powder

Though Fe₄N is suitable for the iron nitride powder, Fe₃N, Fe₂N, or mixtures thereof may be used. Though the iron nitride powder contains inevitable impurities such as carbon, oxygen, etc., the carbon content is preferably 0.02% by mass or less, more preferably 0.007% by mass or less. The average particle size of the iron nitride powder may be substantially the same as that of the composite, soft-magnetic powder, preferably 2-100 μm, more preferably 2-50 μm, most preferably 10-40 μm. Particles of the iron nitride powder are converted to soft-magnetic iron core particles by a heat treatment together with boron powder as described later.

(b) Boron Powder

The boron powder has an average particle size of 0.1-10 μm. When the average particle size is less than 0.1 μm, the boron powder tends to be so aggregated that it cannot be easily mixed with the iron nitride powder. On the other hand, when the average particle size is more than 10 μm, pulverization media should be used to fully mix it with the iron nitride powder, inviting the risk that impurities enter the mixture from the pulverization media. The average particle size of the boron powder is preferably 0.5-10 μm, more preferably 0.5-5 μm.

(2) Mixing Step

The boron powder is preferably added to the iron nitride powder at a B/Fe atomic ratio of 0.03 or more, and mixed by a mortar, a V-type mixer, a Raikai mixer, a ball mill, a bead mill, a rotary mixer, etc. The atomic ratio of B/Fe is preferably 0.8≧B/Fe≧0.03. The B/Fe atomic ratio of more than 0.8 means the use of excess boron not contributing to the formation of coating layers, resulting in high production cost. On the other hand, when the B/Fe atomic ratio is less than 0.03, too small an amount of the boron powder exists between core particles, so that the core particles are sintered together to accelerate the growth of crystal grains, failing to obtain the desired core characteristics. The B/Fe atomic ratio is more preferably 0.8≧B/Fe≧0.1, further preferably 0.8≧B/Fe≧0.125, most preferably 0.8≧B/Fe≧0.25.

(3) Heat Treatment Step

The resultant mixed powder is heat-treated at a temperature of 600-850° C. in a nitrogen atmosphere. The heat treatment is preferably conducted, for example, in an alumina crucible in an electric furnace. This heat treatment forms the composite, soft-magnetic powder in which each particle has a boron nitride-based coating layer on a soft-magnetic, iron-based core particle. Though the nitrogen atmosphere is preferably a pure nitrogen gas, a mixed gas of nitrogen with an inert gas such as Ar, He, etc. or ammonia may be used. When the heat treatment temperature is higher than 850° C., too thick boron nitride-based coating layers are formed, and intrude the core particles, resulting in a low volume ratio of iron, which lowers the soft-magnetic properties of the composite, soft-magnetic powder. On the other hand, when the heat treatment temperature is lower than 600° C., boron nitride-based coating layers are not formed, and with iron nitride as a starting material, iron is not formed because the heat treatment temperature is lower than the decomposition temperature of iron nitride, failing to synthesize a composite, soft-magnetic powder in which each particle has an iron core particle. The preferred heat treatment temperature is 650-800° C. A time period during which the temperature of 600-850° C. is kept (heat treatment time) is preferably 0.5-50 hours, more preferably 1-10 hours, most preferably 1.5-5 hours.

(4) Purification Step

The heat-treated powder is charged into an organic solvent such as isopropyl alcohol (IPA), etc., dispersed by ultrasonic irradiation, and purified by a magnetic separation method for collecting only the soft-magnetic, iron-based core particles by a permanent magnet, with non-magnetic components removed.

[3] Production of Dust Core

The composite, soft-magnetic powder is granulated with a binder added. The binder used is preferably polyvinyl butyral (PVB), polyvinyl alcohol (PVA), acrylic emulsions, colloidal silica, etc. The resultant granules are compression-molded by a die press to produce a dust core. Though properly selected, the compression-molding pressure is preferably, for example, 500-2000 MPa.

The present invention will be explained in more detail referring to Examples below without intention of restricting the present invention thereto.

### Example 1

(1) Production and Measurement of Composite, Soft-Magnetic Powder

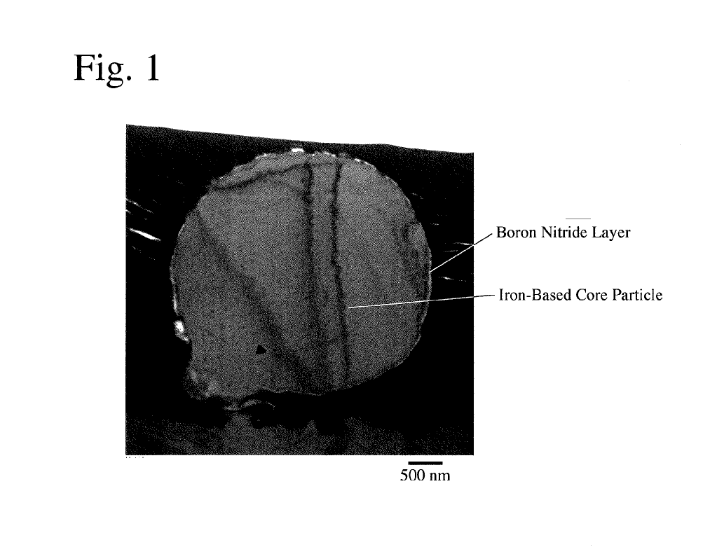

Iron nitride powder (Fe/N atomic ratio=4/1) having an average particle size of 4.4 μm and boron powder having an average particle size of 0.7 μm were mixed at a B/Fe atomic ratio of 0.6, heat-treated at 700° C. for 2 hours in a nitrogen atmosphere, and subjected to magnetic separation in IPA to remove non-magnetic components, thereby obtaining a composite, soft-magnetic powder having an average particle size of 4.3 μm. FIG. 1 is a TEM photograph showing a cross section of the composite, soft-magnetic powder. The iron-based core particle had some surface portions not covered with a boron nitride coating layer, confirming that the core particles were not necessarily coated completely.

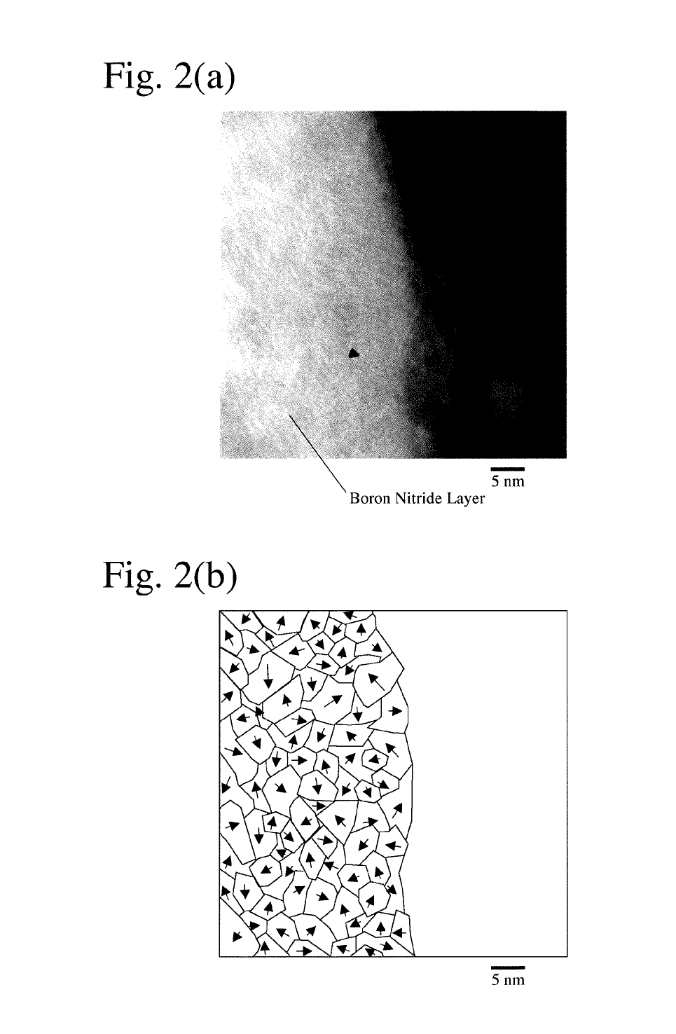

Surface composition analysis by XPS revealed that the coating layers mainly made of boron nitride contained boron oxide, too, and that the ratio of Fe (partially oxide) on the outermost surface was 6.7 atomic %. From a TEM photograph of a cross section of the composite, soft-magnetic powder, and the results of surface composition analysis by XPS, it is presumed that the ratio of Fe on the outermost surface corresponds to the ratio of uncoated surface portions. From the TEM photograph of FIG. 2(a) enlargedly showing the boron nitride coating layer, it was found that the boron nitride coating layer was polycrystalline, having fine boron nitride crystal grains with different C-axis orientations. FIG. 2(b) schematically shows a polycrystalline boron nitride coating layer with different C-axis orientations. In FIG. 2(b), the arrow shows the direction of the C-axis of each crystal. In the TEM photograph showing a cross section of the boron nitride coating layer, an average crystal grain size determined from fine boron nitride crystal grains crossing two arbitrary lines of the same length perpendicular to each other was 4 nm.

The saturation magnetization (maximum magnetization when a magnetic field of 10 kOe was applied) of the composite, soft-magnetic powder measured by VSM was 205 emu/g. Calculated from this saturation magnetization, the average thickness T_{A} of the boron nitride coating layers was 0.15 μm, and the volume ratio of iron was 81%. T_{A}/D_{A} determined from the volume ratio of iron was 3.8%.

(2) Production of Dust Core and Measurement of its Characteristics

The composite, soft-magnetic powder was granulated with a PVB solution in ethanol added, and compression-molded at pressure of 1470 MPa by a hydraulic press, to produce a toroidal dust core of 13.4 mm in outer diameter, 7.7 mm in inner diameter and 4 mm in thickness. The density of the dust core was determined from its mass and size. The coercivity of the dust core was measured by VSM. As a result, it was found that the dust core had a density of 7.0 Mg/m³ and coercivity of 11.1 Oe.

The dust core was put in a resin case, provided with a primary (exciting) winding and a secondary (detecting) winding each constituted by 20 turns of an enameled copper wire having a diameter of 0.25 mm, and measured with respect to loss at an exciting magnetic flux density of 50 mT and a frequency of 50 kHz by a B—H analyzer. As a result, the loss of the dust core was 129 kW/m³.

Transformer cores, etc. are required to have high DC superimposition characteristics. The DC superimposition characteristics of a dust core can be expressed by incremental permeability. Thus, the incremental permeability of the dust core was measured by the following method. With the dust core put in a resin case and provided with 20 turns of an enameled copper wire having a diameter of 0.7 mm, its inductance was measured at a frequency of 100 kHz by an LCR meter. The incremental permeability was calculated by the following formula (1):

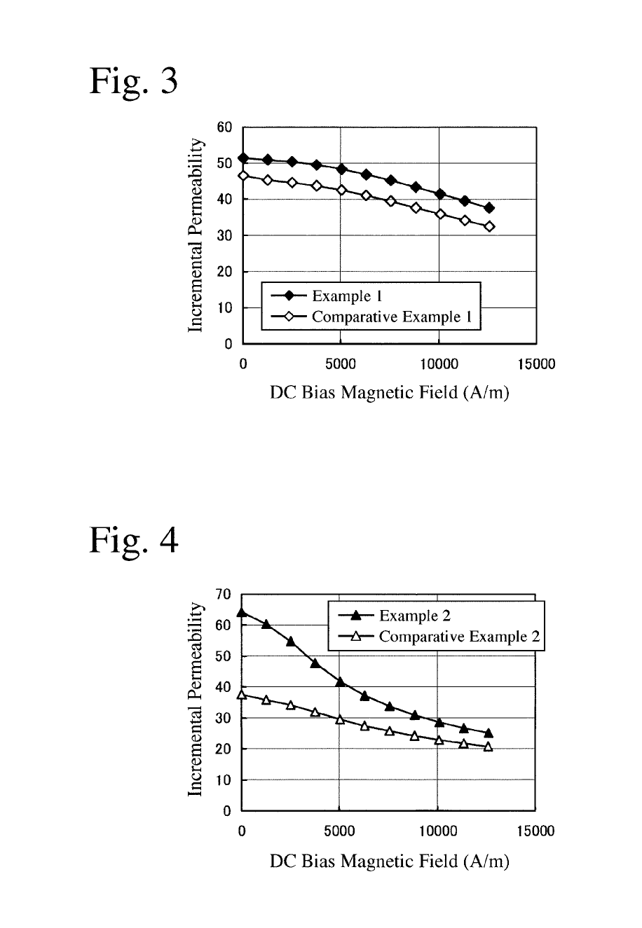

L=μ₀μ_{rΔ}N²Aₑ/lₑ (1),
wherein L is inductance [H],
μ₀ is permeability of vacuum=4π×10⁻⁷ [H/m],
μ_{rΔ} is incremental permeability,
N is the number of windings,
Aₑ is an effective cross section area [m²], and
lₑ is an effective magnetic path length [m].
   The relation between the incremental permeability and a DC bias magnetic field is shown in FIG. 3.

### Comparative Example 1

Commercially available iron powder (SQ available from BASF) having an average particle size of 3.5 μm and saturation magnetization of 204 emu/g, the ratio of Fe on the outermost surface being 24.6 atomic %, was granulated with a PVB solution in ethanol added, compression-molded at pressure of 1470 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had a density of 6.9 Mg/m³, coercivity of 19.9 Oe, and loss of 176 kW/m³. The relation between the incremental permeability and a DC bias magnetic field is shown in FIG. 3.

### Example 2

Iron nitride powder (Fe/N atomic ratio=4/1) having an average particle size of 47 μm and boron powder having an average particle size of 0.7 μm was mixed at a B/Fe atomic ratio of 0.6, heat-treated at 800° C. for 2 hours in a nitrogen atmosphere, and deprived of non-magnetic components by magnetic separation in IPA to obtain a composite, soft-magnetic powder. The composite, soft-magnetic powder had an average particle size of 30 μm and saturation magnetization of 196 emu/g, the volume ratio of iron being 71%, the ratio of Fe on the outermost surface being 6.0 atomic %, and the average crystal grain size of boron nitride being 12 nm. TEM photograph observation revealed that the boron nitride coating layers were polycrystalline, having different C-axis orientations. The average thickness T_{A} of the boron nitride coating layers calculated from saturation magnetization was 1.6 μm, and T_{A}/D_{A} determined from the volume ratio of iron was 6.0%.

The composite, soft-magnetic powder was granulated with a PVB solution in ethanol added, compression-molded at pressure of 1960 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had a density of 6.8 Mg/m³, coercivity of 15.5 Oe, and loss of 284 kW/m³. The relation between the incremental permeability and a DC bias magnetic field is shown in FIG. 4.

### Comparative Example 2

Commercially available iron powder (available from Kojundo Chemical Laboratory Co., Ltd.) having an average particle size of 36 μm and saturation magnetization of 198 emu/g, the ratio of Fe on the outermost surface being 23.7 atomic %, was granulated with a PVB solution in ethanol added, compression-molded at pressure of 1960 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had a density of 6.5 Mg/m³, coercivity of 30.5 Oe, and loss of 550 kW/m³. The relation between the incremental permeability and a DC bias magnetic field is shown in FIG. 4.

### Example 3

Iron nitride powder (Fe/N atomic ratio=4/1) having an average particle size of 90 μm and boron powder having an average particle size of 0.7 μm were mixed at a B/Fe atomic ratio of 0.6, heat-treated at 800° C. for 2 hours in a nitrogen atmosphere, and deprived of non-magnetic components by magnetic separation in IPA to obtain a composite, soft-magnetic powder. The composite, soft-magnetic powder had an average particle size of 85 μm and saturation magnetization of 198 emu/g, the volume ratio of iron being 73%, the ratio of Fe on the outermost surface being 11.5 atomic %, with boron nitride having an average crystal grain size of 10 nm. TEM photograph observation revealed that the boron nitride coating layers were polycrystalline, having different C-axis orientations. The average thickness T_{A} of the boron nitride coating layers calculated from saturation magnetization was 4.1 μm, and T_{A}/D_{A} determined from the volume ratio of iron was 4.9%.

The composite, soft-magnetic powder was granulated with a PVB solution in ethanol added, compression-molded at pressure of 1960 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had a density of 7.1 Mg/m³, coercivity of 18.2 Oe, and loss of 528 kW/m³.

### Comparative Example 3

Commercially available iron powder having an average particle size of 90 μm and saturation magnetization of 199 emu/g, the ratio of Fe on the outermost surface being 24.1 atomic %, was granulated with a PVB solution in ethanol added, compression-molded at pressure of 1960 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had a density of 7.0 Mg/m³, coercivity of 27.0 Oe, and loss of 667 kW/m³.

The average particle sizes and B/Fe atomic ratios of the iron nitride powder and the boron powder, and heat treatment temperatures are shown in Table 1. The average particle sizes, volume ratios of iron, ratios of Fe on the outermost surface, and saturation magnetization of the composite, soft-magnetic powders, and the average particle sizes of D_{A} of the core particles are shown in Table 2. The average thicknesses T_{A} and average crystal grain sizes and T_{A}/D_{A} of the coating layers are shown in Table 3. The densities, coercivities and losses of the dust cores are shown in Table 4. The surface compositions and chemical states of the composite, soft-magnetic powders are shown in Table 5.

As is clear from Tables 3 and 4, the dust cores formed by the composite, soft-magnetic powders of the present invention, in which the ratios of Fe on the outermost surface are 12 atomic % or less, have higher densities than those of the dust cores of Comparative Examples formed by iron powders with no coating layers. This appears to be due to the lubrication effect of the boron nitride coating layers. Accordingly, the dust cores of the present invention had higher permeabilities, higher DC superimposition characteristics and lower losses than those of the dust cores of Comparative Examples. Because the level of loss changes largely depending on the powder sizes, the comparison of the loss was conducted between dust cores of powders having the same particle sizes.

TABLE 1

| | Average Particle Size of Starting | | | | |
|---|---|---|---|---|---|
| | Material Powder (μm) | | | B/Fe | Heat Treatment |
| | Iron nitride | Iron | Boron | Atomic | Temperature |
| No. | Powder | Powder | Powder | Ratio | (° C.) |
| Example 1 | 4.4 | — | 0.7 | 0.6 | 700 |
| Comparative | — | 3.5 | — | — | — |
| Example 1 | | | | | |
| Example 2 | 47 | — | 0.7 | 0.6 | 800 |
| Comparative | — | 36 | — | — | — |
| Example 2 | | | | | |
| Example 3 | 90 | — | 0.7 | 0.6 | 800 |
| Comparative | — | 90 | — | — | — |
| Example 3 | | | | | |

TABLE 2

| | Composite, Soft-Magnetic Powder | | | | Average |
|---|---|---|---|---|---|
| | Average | Volume | Ratio of | Saturation | Particle Size |
| | Particle | Ratio of | Fe⁽¹⁾ | Magnetization | D_{A} of Core |
| No. | Size (μm) | Iron (%) | (atomic %) | (emu/g) | Particles (μm) |
| Example 1 | 4.3 | 81 | 6.7 | 205 | 4.0 |
| Comparative | 3.5 | — | 24.6 | 204 | 3.5 |
| Example 1 | | | | | |
| Example 2 | 30 | 71 | 6.0 | 196 | 26.8 |
| Comparative | 36 | — | 23.7 | 198 | 36 |
| Example 2 | | | | | |
| Example 3 | 85 | 73 | 11.5 | 198 | 76.8 |
| Comparative | 90 | — | 24.1 | 199 | 90 |
| Example 3 | | | | | |

Note:
⁽¹⁾The ratio of Fe on the outermost surface.

TABLE 3

| | Coating Layer | | |
|---|---|---|---|
| | Average | Average | |
| | Thickness | Crystal Grain | T_{A}/D_{A} |
| No. | T_{A}(μm) | Size (nm) | (%) |
| Example 1 | 0.15 | 4 | 3.8 |
| Comparative | — | — | — |
| Example 1 | | | |
| Example 2 | 1.6 | 12 | 6.0 |
| Comparative | — | — | — |
| Example 2 | | | |
| Example 3 | 4.1 | 10 | 4.9 |
| Comparative | — | — | — |
| Example 3 | | | |

TABLE 4

| | Dust Core | | |
|---|---|---|---|
| | Density | Coercivity | Loss |
| No. | (Mg/m³) | (Oe) | (kW/m³) |
| Example 1 | 7.0 | 11.1 | 129 |
| Comparative | 6.9 | 19.9 | 176 |
| Example 1 | | | |
| Example 2 | 6.8 | 15.5 | 284 |
| Comparative | 6.5 | 30.5 | 550 |
| Example 2 | | | |
| Example 3 | 7.1 | 18.2 | 528 |
| Comparative | 7.0 | 27.0 | 667 |
| Example 3 | | | |

TABLE 5

| | Surface Composition (atomic %) And Chemical State of | | | | | |
|---|---|---|---|---|---|---|
| | Composite, Soft-Magnetic Powder | | | | | |
| | B | | | | Fe | |
| No. | Nitride | Oxide | N | O | Metal | Oxide |
| Example 1 | 15.8 | 15.8 | 23.3 | 38.3 | 0.9 | 5.8 |
| Example 2 | 21.9 | 9.3 | 27.4 | 35.4 | 0.7 | 5.3 |

### Comparative Example 4

Iron nitride powder (Fe/N atomic ratio=4/1) having an average particle size of 4.4 μm and boron powder having an average particle size of 0.7 μm were mixed at a B/Fe atomic ratio of 0.6, heat-treated at 500° C. for 2 hours in a nitrogen atmosphere, and deprived of non-magnetic components by magnetic separation in IPA. However, because the heat treatment temperature was 500° C., too low, substantially no change occurred in the iron nitride powder as a starting material, failing to obtain a composite, soft-magnetic powder with cores of iron particles.

### Example 4

Iron nitride powder (Fe/N atomic ratio=4/1) having an average particle size of 4.4 μm and boron powder having an average particle size of 0.7 μm were mixed at a B/Fe atomic ratio of 0.6, heat-treated at 600° C. for 2 hours in a nitrogen atmosphere, and deprived of non-magnetic components by magnetic separation in IPA to obtain a composite, soft-magnetic powder. The composite, soft-magnetic powder had an average particle size of 4.3 μm and saturation magnetization of 205 emu/g, the volume ratio of iron being 81%, the ratio of Fe on the outermost surface being 11.7 atomic %, and the average crystal grain size of boron nitride being 3 nm. TEM photograph observation revealed that the boron nitride coating layers were polycrystalline, having different C-axis orientations. The average thickness T_{A} of the boron nitride coating layers calculated from saturation magnetization was 0.15 μm, and T_{A}/D_{A} determined from the volume ratio of iron was 3.8%.

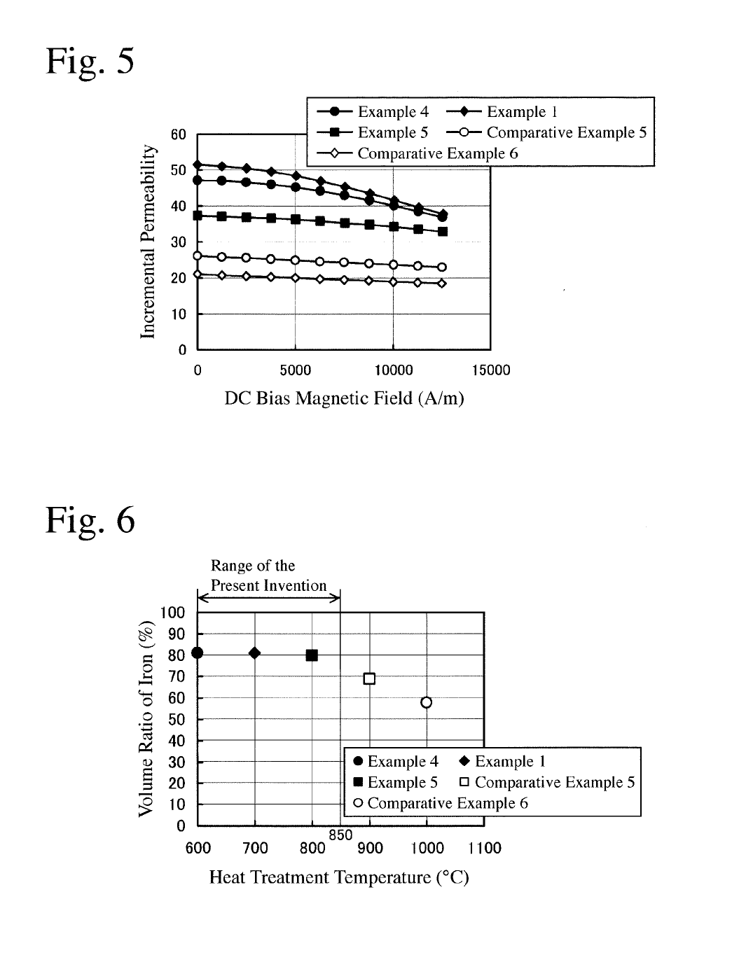

The composite, soft-magnetic powder was granulated with a PVB solution in ethanol added, compression-molded at pressure of 1470 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had a density of 7.0 Mg/m³, coercivity of 14.7 Oe, and loss of 153 kW/m³. The relation between the incremental permeability and a DC bias magnetic field is shown in FIG. 5.

### Example 5

Iron nitride powder (Fe/N atomic ratio=4/1) having an average particle size of 4.4 μm and boron powder having an average particle size of 0.7 μm were mixed at a B/Fe atomic ratio of 0.6, heat-treated at 800° C. for 2 hours in a nitrogen atmosphere, and deprived of non-magnetic components by magnetic separation in IPA to obtain a composite, soft-magnetic powder. The composite, soft-magnetic powder had an average particle size of 4.3 μm and saturation magnetization of 204 emu/g, the volume ratio of iron being 80%, the ratio of Fe on the outermost surface being 5.0 atomic %, and the average crystal grain size of boron nitride being 8 nm. TEM photograph observation revealed that the boron nitride coating layers were polycrystalline, having different C-axis orientations. The average thickness T_{A} of the boron nitride coating layers calculated from saturation magnetization was 0.16 μm, and T_{A}/D_{A} determined from the volume ratio of iron was 4.0%.

The composite, soft-magnetic powder was granulated with a PVB solution in ethanol added, and compression-molded at pressure of 1470 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had a density of 6.7 Mg/m³, coercivity of 13.2 Oe, and loss of 128 kW/m³. The relation between the incremental permeability and a DC bias magnetic field is shown in FIG. 5.

### Comparative Example 5

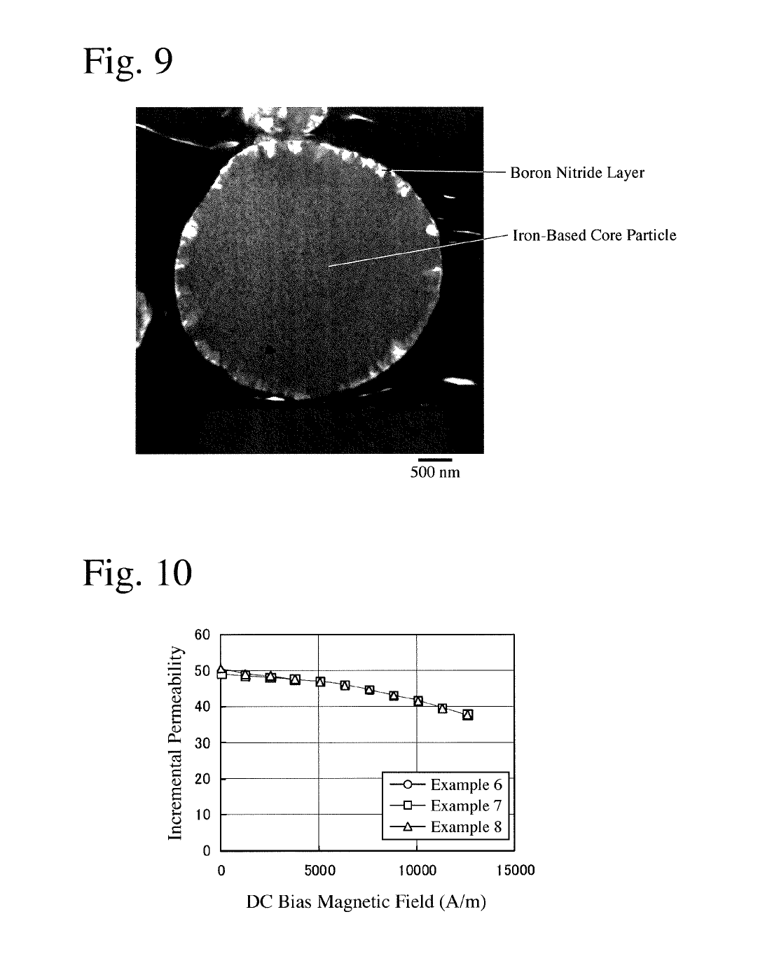

Iron nitride powder (Fe/N atomic ratio=4/1) having an average particle size of 4.4 μm and boron powder having an average particle size of 0.7 μm were mixed at a B/Fe atomic ratio of 0.6, heat-treated at 900° C. for 2 hours in a nitrogen atmosphere, and deprived of non-magnetic components by magnetic separation in IPA to obtain a composite, soft-magnetic powder. The composite, soft-magnetic powder had an average particle size of 4.6 μm and saturation magnetization of 194 emu/g, the volume ratio of iron being 69%, the ratio of Fe on the outermost surface being 1.1 atomic %, and the average crystal grain size of boron nitride being 16 nm. The average thickness T_{A} of the boron nitride coating layers was 0.28 μm, and T_{A}/D_{A} determined from the volume ratio of iron was 6.9%. FIG. 9 is a TEM photograph showing a cross section of the composite, soft-magnetic powder. As is clear from FIG. 9, because of too high a heat treatment temperature of 900° C., unnecessarily thick boron nitride coating layers were formed.

The composite, soft-magnetic powder was granulated with a PVB solution in ethanol added, and compression-molded at pressure of 1470 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had a density of 5.9 Mg/m³, coercivity of 24.0 Oe, and loss of 222 kW/m³. The relation between the incremental permeability and a DC bias magnetic field is shown in FIG. 5.

### Comparative Example 6

Iron nitride powder (Fe/N atomic ratio=4/1) having an average particle size of 4.4 μm and boron powder having an average particle size of 0.7 μm were mixed at a B/Fe atomic ratio of 0.6, heat-treated at 1000° C. for 2 hours in a nitrogen atmosphere, and deprived of non-magnetic components by magnetic separation in IPA to obtain a composite, soft-magnetic powder. The composite, soft-magnetic powder had an average particle size of 5.0 μm and saturation magnetization of 182 emu/g, the volume ratio of iron being 58%, and the average crystal grain size of boron nitride being 20 nm. The average thickness T_{A} of the boron nitride coating layers was 0.40 μm, and T_{A}/D_{A} determined from the volume ratio of iron was 9.5%. Because of too high a heat treatment temperature of 1000° C., unnecessarily thick boron nitride coating layers were formed.

The composite, soft-magnetic powder was granulated with a PVB solution in ethanol added, and compression-molded at pressure of 1470 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had a density of 5.4 Mg/m³, coercivity of 32.0 Oe, and loss of 318 kW/m³. The relation between the incremental permeability and a DC bias magnetic field is shown in FIG. 5.

The average particle sizes and B/Fe atomic ratios the iron nitride powders and boron powders, and heat treatment temperatures are shown in Table 6. The average particle sizes, volume ratios of iron, ratios of Fe on the outermost surface and saturation magnetization of the composite, soft-magnetic powders, and the average particle sizes D_{A} of core particles are shown in Table 7. The average thicknesses T_{A} and average crystal grain sizes, and T_{A}/D_{A} of the coating layers are shown in Table 8. The densities, coercivities and losses of the dust cores are shown in Table 9. The surface compositions and chemical states of the composite, soft-magnetic powders are shown in Table 10.

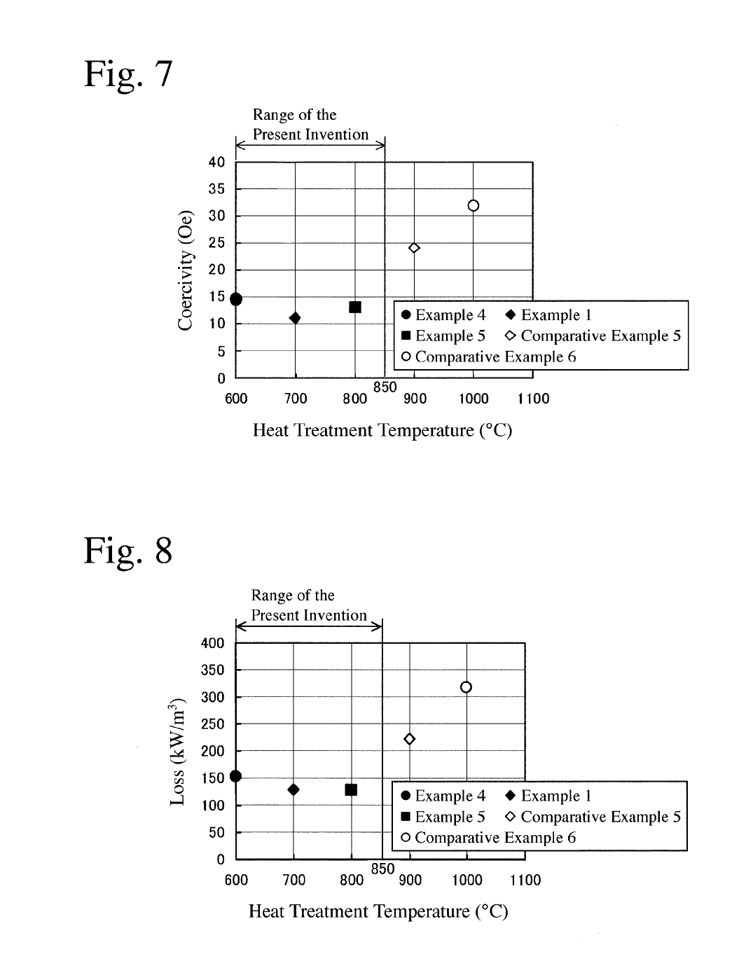

The relations between the volume ratio of iron and the heat treatment temperature in the composite, soft-magnetic powders are shown in FIG. 6, the relations between the coercivity of the dust cores and the heat treatment temperature are shown in FIG. 7, and the relations between the loss of the dust cores and the heat treatment temperature are shown in FIG. 8. As shown in FIG. 9, a boron nitride coating layer in the composite, soft-magnetic powder of Comparative Example 5 was not only as thick as 300 nm at maximum, but also partially intruded into core particles. Accordingly, the volume ratio of iron and the saturation magnetization of the dust core were smaller than those of Example 1. In addition, the boron nitride coating layers were broken during compression molding, failing to sufficiently exhibit a function as insulating layers.

As is clear from Tables 6-8 and FIGS. 5-9, within the heat treatment temperature range of the present invention, composite, soft-magnetic powders having boron nitride coating layers having proper thickness and average crystal grain sizes, the volume ratios of iron being 70% or more, can be obtained. However, when the heat treatment temperature is 900° C. or higher as in Comparative Examples 5 and 6, too thick boron nitride coating layers are formed, resulting in low volume ratios of iron, and large average crystal grain sizes of boron nitride. Oppositely, when the heat treatment temperature is lower than 600° C. as in Comparative Example 4, boron nitride-based coating layers are not formed, failing to synthesize composite, soft-magnetic powders with iron particle cores.

Using the composite, soft-magnetic powders of the present invention, dust cores having coercivity of less than 24 Oe can be obtained. With the coercivity of less than 24 Oe, the dust cores have small loss. This indicates that the use of composite, soft-magnetic powders synthesized within the heat treatment temperature range of the present invention can provide dust cores with high permeability, excellent DC superimposition characteristics, and low loss.

TABLE 6

| | Average Particle Size of Starting | | | |
|---|---|---|---|---|
| | Material Powder (μm) | | B/Fe | Heat Treatment |
| | Iron Nitride | Boron | Atomic | Temperature |
| No. | Powder | Powder | Ratio | (° C.) |
| Comparative | 4.4 | 0.7 | 0.6 | 500 |
| Example 4 | | | | |
| Example 4 | 4.4 | 0.7 | 0.6 | 600 |
| Example 1 | 4.4 | 0.7 | 0.6 | 700 |
| Example 5 | 4.4 | 0.7 | 0.6 | 800 |
| Comparative | 4.4 | 0.7 | 0.6 | 900 |
| Example 5 | | | | |
| Comparative | 4.4 | 0.7 | 0.6 | 1000 |
| Example 6 | | | | |

TABLE 7

| | Composite, Soft-Magnetic Powder | | | | Average |
|---|---|---|---|---|---|
| | Average | Volume | Ratio of | Saturation | Particle Size |
| | Particle | Ratio of | Fe⁽¹⁾ | Magnetization | D_{A} of Core |
| No. | Size (μm) | Iron (%) | (atomic %) | (emu/g) | Particles (μm) |
| Comparative | — | — | — | — | — |
| Example 4 | | | | | |
| Example 4 | 4.3 | 81 | 11.7 | 205 | 4.0 |
| Example 1 | 4.3 | 81 | 6.7 | 205 | 4.0 |
| Example 5 | 4.3 | 80 | 5.0 | 204 | 3.98 |
| Comparative | 4.6 | 69 | 1.1 | 194 | 4.04 |
| Example 5 | | | | | |
| Comparative | 5.0 | 58 | — | 182 | 4.2 |
| Example 6 | | | | | |

Note:
⁽¹⁾The ratio of Fe on the outermost surface.

TABLE 8

| | Coating Layer | | |
|---|---|---|---|
| | Average | Average | |
| | Thickness | Crystal Grain | T_{A}/D_{A} |
| No. | T_{A} (μm) | Size (nm) | (%) |
| Comparative | — | — | — |
| Example 4 | | | |
| Example 4 | 0.15 | 3 | 3.8 |
| Example 1 | 0.15 | 4 | 3.8 |
| Example 5 | 0.16 | 8 | 4.0 |
| Comparative | 0.28 | 16 | 6.9 |
| Example 5 | | | |
| Comparative | 0.40 | 20 | 9.5 |
| Example 6 | | | |

TABLE 9

| | Dust Core | | |
|---|---|---|---|
| | Density | Coercivity | Loss |
| No. | (Mg/m³) | (Oe) | (kW/m³) |
| Comparative | — | — | — |
| Example 4 | | | |
| Example 4 | 7.0 | 14.7 | 153 |
| Example 1 | 7.0 | 11.1 | 129 |
| Example 5 | 6.7 | 13.2 | 128 |
| Comparative | 5.9 | 24.0 | 222 |
| Example 5 | | | |
| Comparative | 5.4 | 32.0 | 318 |
| Example 6 | | | |

TABLE 10

| | Surface Composition (atomic %) And Chemical State of | | | | | |
|---|---|---|---|---|---|---|
| | Composite, Soft-Magnetic Powder | | | | | |
| | B | | | | Fe | |
| No. | Nitride | Oxide | N | O | Metal | Oxide |
| Comparative | — | — | — | — | — | — |
| Example 4 | | | | | | |
| Example 4 | 5.2 | 14.1 | 8.8 | 60.1 | 1.5 | 10.2 |
| Example 1 | 15.8 | 15.8 | 23.3 | 38.3 | 0.9 | 5.8 |
| Example 5 | 24.8 | 8.4 | 31.0 | 30.7 | 0.4 | 4.6 |
| Comparative | 36.5 | 6.2 | 44.2 | 12.0 | 0.2 | 0.9 |
| Example 5 | | | | | | |

### Example 6

Iron nitride powder (Fe/N atomic ratio=4/1) having an average particle size of 4.4 μm and boron powder having an average particle size of 0.7 μm were mixed at a B/Fe atomic ratio of 0.25, heat-treated at 700° C. for 2 hours in a nitrogen atmosphere, and deprived of non-magnetic components by magnetic separation in IPA to obtain a composite, soft-magnetic powder. The ratio of Fe on the outermost surface was 6.0 atomic %. TEM photograph observation revealed that the boron nitride coating layers were polycrystalline, having different C-axis orientations.

The composite, soft-magnetic powder was granulated with a PVB solution in ethanol added, compression-molded at pressure of 1470 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had loss of 153 kW/m³. The relation between the incremental permeability and a DC bias magnetic field is shown in FIG. 10.

### Example 7

Iron nitride powder (Fe/N atomic ratio=4/1) having an average particle size of 4.4 μm and boron powder having an average particle size of 0.7 μm were mixed at a B/Fe atomic ratio of 0.125, heat-treated at 700° C. for 2 hours in a nitrogen atmosphere, and deprived of non-magnetic components by magnetic separation in IPA to obtain a composite, soft-magnetic powder. The ratio of Fe on the outermost surface was 5.3 atomic %. TEM photograph observation revealed that the boron nitride coating layers were polycrystalline, having different C-axis orientations.

The composite, soft-magnetic powder was granulated with a PVB solution in ethanol added, compression-molded at pressure of 1470 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had loss of 146 kW/m³. The relation between the incremental permeability and a DC bias magnetic field is shown in FIG. 10.

### Example 8

Iron nitride powder (Fe/N atomic ratio=4/1) having an average particle size of 4.4 μm and boron powder having an average particle size of 0.7 μm were mixed at a B/Fe atomic ratio of 0.05, heat-treated at 700° C. for 2 hours in a nitrogen atmosphere, and deprived of non-magnetic components by magnetic separation in IPA to obtain a composite, soft-magnetic powder. The ratio of Fe on the outermost surface was 6.4 atomic %. TEM photograph observation revealed that the boron nitride coating layers were polycrystalline, having different C-axis orientations.

The composite, soft-magnetic powder was granulated with a PVB solution in ethanol added, compression-molded at pressure of 1470 MPa by a hydraulic press to produce a toroidal dust core of 13.4 mm in outer diameter, 7.7 mm in inner diameter and 4 mm in thickness, and evaluated under the same conditions as in Example 1. As a result, it was found that the dust core had loss of 170 kW/m³. The relation between the incremental permeability and a DC bias magnetic field is shown in FIG. 10.

### Comparative Example 7

Iron nitride powder (Fe/N atomic ratio=4/1) having an average particle size of 4.4 μm and boron powder having an average particle size of 0.7 μm were mixed at a B/Fe atomic ratio of 0.025, and heat-treated at 700° C. for 2 hours in a nitrogen atmosphere. However, the iron powder was sintered to a hard block, failing to obtain a composite, soft-magnetic powder.

As is clear from Tables 11-13, as long as the B/Fe atomic ratio is within the range of the present invention, good core characteristics with substantially the same molding density are obtained without large difference in the ratios of Fe on the outermost surface, even when the B/Fe atomic ratios are small as in Examples 6-8. However, when the B/Fe atomic ratio is less than 0.03 as in Comparative Example 7, the growth of crystal grains is accelerated by the sintering of the iron-based core particles, failing to provide a composite, soft-magnetic powder suitable for compression molding. On the other hand, too much B does not provide the composite, soft-magnetic powder with improved magnetic properties, merely resulting in a high cost. Accordingly, 0.8≧B/Fe≧0.03 is preferable.

TABLE 11

| | Average Particle Size of Starting | | | |
|---|---|---|---|---|
| | Material Powder (μm) | | B/Fe | Heat Treatment |
| | Iron Nitride | Boron | Atomic | Temperature |
| No. | Powder | Powder | Ratio | (° C.) |
| Example 1 | 4.4 | 0.7 | 0.6 | 700 |
| Example 6 | 4.4 | 0.7 | 0.25 | 700 |
| Example 7 | 4.4 | 0.7 | 0.125 | 700 |
| Example 8 | 4.4 | 0.7 | 0.05 | 700 |
| Comparative | 4.4 | 0.7 | 0.025 | 700 |
| Example 7 | | | | |

TABLE 12

| | Surface Composition (atomic %) And Chemical State of | | | | | |
|---|---|---|---|---|---|---|
| | Composite, Soft-Magnetic Powder | | | | | |
| | B | | | | Fe | |
| No. | Nitride | Oxide | N | O | Metal | Oxide |
| Example 1 | 15.8 | 15.8 | 23.3 | 38.3 | 0.9 | 5.8 |
| Example 6 | 16.1 | 16.5 | 24.1 | 37.4 | 0.7 | 5.3 |
| Example 7 | 20.1 | 13.4 | 26.3 | 34.9 | 0.7 | 4.6 |
| Example 8 | 15.1 | 15.4 | 21.3 | 41.8 | 0.7 | 5.7 |

TABLE 13

| | Ratio of Fe⁽¹⁾ |
|---|---|
| No. | (atomic %) |
| Example 1 | 6.7 |
| Example 6 | 6.0 |
| Example 7 | 5.3 |
| Example 8 | 6.4 |

Note:
⁽¹⁾The ratio of Fe on the outermost surface.

TABLE 14

| | Dust Core | | |
|---|---|---|---|
| | Density | Coercivity | Loss |
| No. | (Mg/m³) | (Oe) | (kW/m³) |
| Example 1 | 7.0 | 11.1 | 129 |
| Example 6 | 6.9 | 15.2 | 153 |
| Example 7 | 6.9 | 12.0 | 146 |
| Example 8 | 6.9 | 19.6 | 170 |
| Comparative | — | — | — |
| Example 7* | | | |

Note:
*Because the composite, soft-magnetic powder was not formed, the dust core was not produced.

### Example 9

A dust core was produced and evaluated in the same manner as in Example 1 except for changing the compression-molding pressure to 1030 MPa. The density and loss of the dust core are shown in Table 15.

### Example 10

A dust core was produced and evaluated in the same manner as in Example 1 except for changing the compression-molding pressure to 520 MPa. The density and loss of the dust core are shown in Table 15.

### Example 11

A dust core was produced and evaluated in the same manner as in Example 1 except for changing the compression-molding pressure to 310 MPa. The density and loss of the dust core are shown in Table 15.

### Comparative Example 8

A dust core was produced and evaluated in the same manner as in Comparative Example 1 except for changing the compression-molding pressure to 1030 MPa. The density and loss of the dust core are shown in Table 15.

### Comparative Example 9

A dust core was produced and evaluated in the same manner as in Comparative Example 1 except for changing the compression-molding pressure to 520 MPa. The density and loss of the dust core are shown in Table 15.

### Comparative Example 10

A dust core was produced and evaluated in the same manner as in Comparative Example 1 except for changing the compression-molding pressure to 310 MPa. The density and loss of the dust core are shown in Table 15.

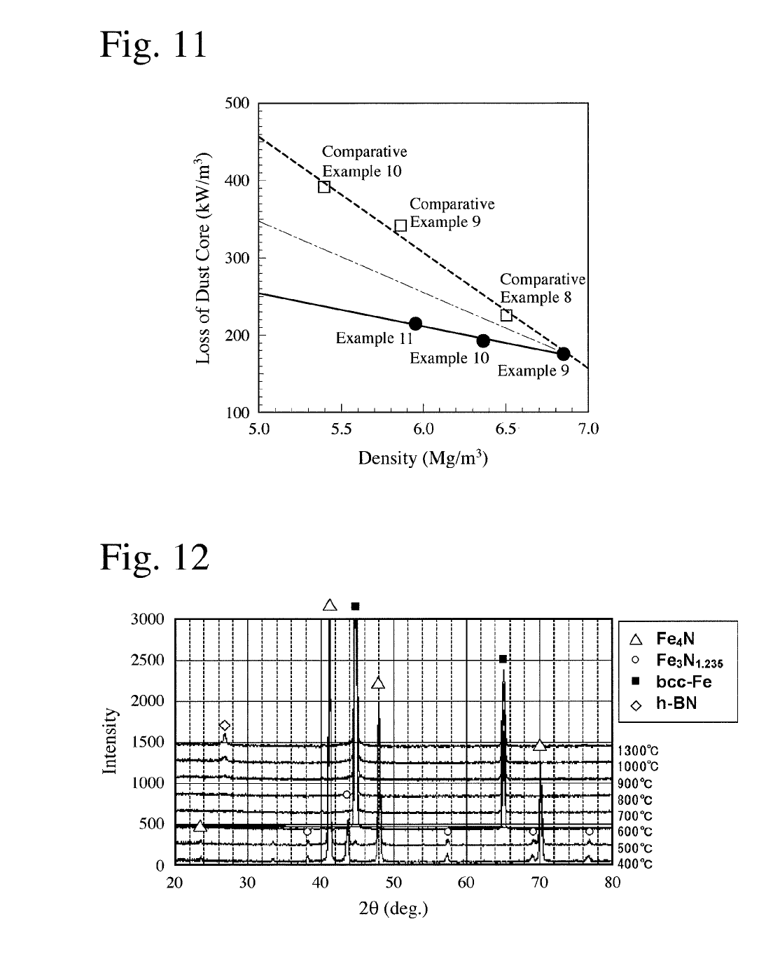

The relations between the densities of the dust cores and their losses are shown in FIG. 11. Lines shown in FIG. 11 were obtained by a least-squares method. At the same density, the dust cores of Examples had smaller losses than those of the dust cores of Comparative Examples. This tendency was remarkable at low densities (low molding pressures). For example, when the density was 6.0 Mg/m³, the loss of Comparative Example was 308 kW/m³, while the loss of Example was as small as 214 kW/m³. This appears to be due to the fact that the solid lubrication function of boron nitride provides dust cores with high densities and little strain even at low molding pressures, and that high density increases the magnetic coupling of core particles in the dust core, resulting in low hysteresis loss. The change rate of said core loss per density change (dP/dρ) is shown in Table 15. The dP/dρ in Examples 9-11 was −42, a half or less of those of Comparative Examples. Thus, the dust cores formed by the composite, soft-magnetic powder of the present invention stably have low losses regardless of density variations, suitable for mass production.

TABLE 15

| | Compression- | | | |
|---|---|---|---|---|
| | Molding | Dust Core | | |
| | Pressure | Density ρ | Loss P | dP/dρ |
| No. | (MPa) | (Mg/m³) | (kW/m³) | (kW/m³)/(Mg/m³) |
| Example 9 | 1030 | 6.85 | 176 | −42 |
| Example 10 | 520 | 6.36 | 192 | −42 |
| Example 11 | 310 | 5.95 | 214 | −42 |
| Comparative | 1030 | 6.51 | 225 | −150 |
| Example 8 | | | | |
| Comparative | 520 | 5.87 | 341 | −150 |
| Example 9 | | | | |
| Comparative | 310 | 5.40 | 391 | −150 |
| Example 10 | | | | |

### Example 12

90% by mass of iron nitride powder (Fe/N atomic ratio=4/1) having an average particle size of 4.4 μm and 10% by mass of boron powder having an average particle size of 0.7 μm were mixed, heat-treated at each temperature of 400° C., 500° C., 600° C., 700° C., 800° C., 900° C., 1000° C. and 1300° C. for 2 hours in a nitrogen atmosphere, and deprived of non-magnetic components by magnetic separation in IPA to obtain composite, soft-magnetic powders. The relations between the XRD intensities of the composite, soft-magnetic powders and their heat treatment temperatures are shown in FIG. 12. As is clear from FIG. 12, composite, soft-magnetic powders heat-treated at low temperatures of 500° C. or lower contained Fe₄N with no Fe—B compounds, while those heat-treated at high temperatures of 600° C. or higher contained neither Fe₄N nor Fe—B compounds. This means that Fe₄N was completely decomposed to bcc-Fe without being converted to the Fe—B compounds. Thus, in the method of the present invention using iron nitride powder as a starting material, the boron nitride coating layers are formed on iron nitride particles without the formation of the Fe—B compounds.

SEM observation confirmed that the boron nitride coating layers were formed on the composite, soft-magnetic powders by heat treatments of 700° C. and 800° C. With the heat treatments of 700° C. and 800° C., the average thickness of boron nitride coating layers was 3.8% and 4.0%, respectively, of the core particle sizes. In the composite, soft-magnetic powder obtained by a heat treatment of 900° C., however, the average thickness of boron nitride coating layers was more than 6.6% of the core particle sizes, resulting in dust cores having low space factors. At a heat treatment temperature of 1300° C., thicker boron nitride coating layers were formed. This indicates that the heat treatment temperature is preferably 600-850° C. The observation of TEM photographs revealed that the boron nitride coating layers obtained by heat treatment temperatures of 700° C. and 800° C. were polycrystalline, having different C-axis orientations.

### Comparative Example 11

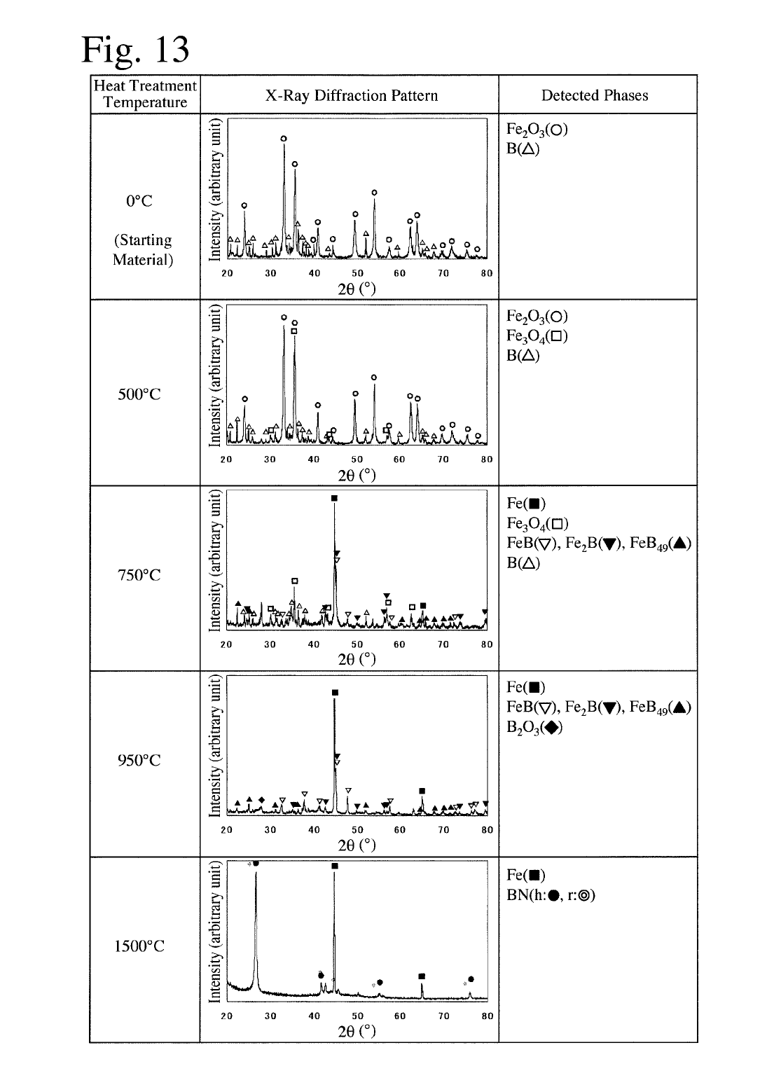

50% by mass of α-Fe₂O₃ powder having an average particle size of 0.03 μm and 50% by mass of boron powder having an average particle size of 30 μm were mixed for 10 minutes in a V-type mixer, heat-treated for 15 minutes in an alumina boat in a furnace in a nitrogen stream at a flow rate of 2 L/minute, at each temperature of 500° C., 750° C., 950° C. and 1500° C., which was achieved by elevating the temperature at a speed of 3° C./minute from room temperature, and deprived of non-magnetic components by magnetic separation in IPA to obtain composite, soft-magnetic powders. X-ray diffraction measurement was conducted on each composite, soft-magnetic powder and the starting material before the heat treatment. FIG. 13 shows the results of XRD measurement. As is clear from FIG. 13, FeB, Fe₂B and FeB₄₉ were detected in the composite, soft-magnetic powders heat-treated at 750° C. and 950° C., while not Fe—B but boron nitride was detected in the composite, soft-magnetic powder heat-treated at 1500° C. This indicates that when iron oxide powder and boron powder are used as starting materials, the Fe—B compounds are once formed, and then boron nitride is formed, different from the reaction steps of the present invention.

### Comparative Example 12

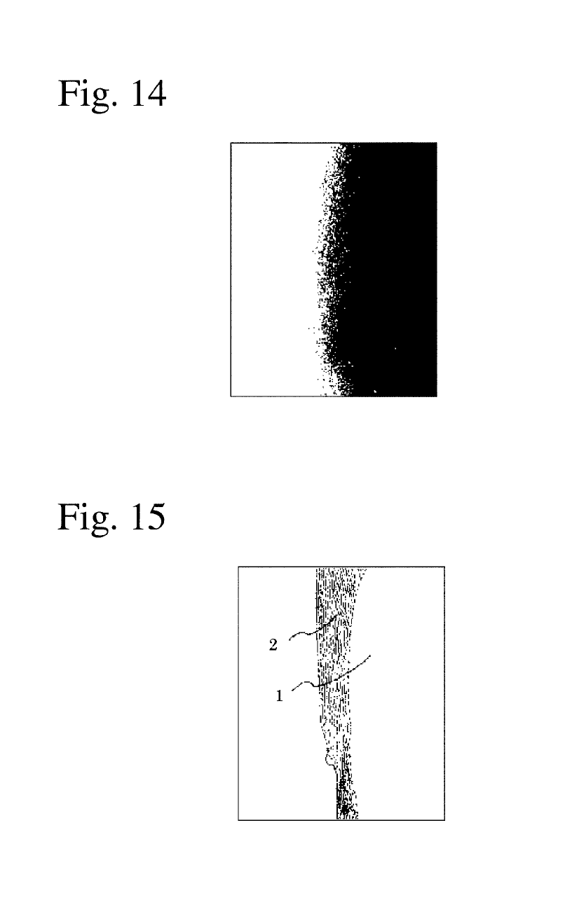

A composite, soft-magnetic powder was produced by the same method as in Comparative Example 11, except that it was heat-treated at 1100° C. for 2 hours. FIG. 14 is a TEM photograph (magnification: 1,000,000 times) showing a boron nitride coating layer of the composite, soft-magnetic powder, and FIG. 15 is its schematic view. The boron nitride coating layer was composed of multilayer, film-like crystals with C-axis orientations substantially aligned in radial directions, different from the polycrystalline boron nitride coating layer of the present invention composed of fine crystal grains with different C-axis orientations. As is clear from FIG. 15, the laminar boron nitride coating layer of Comparative Example 12 had a crystal lattice in a stripe pattern. Lattice planes 2 were laminated substantially in parallel with the surface of iron-based core particle 1.

### EFFECTS OF THE INVENTION

Because the composite, soft-magnetic powder of the present invention each comprising a soft-magnetic, iron-based core particle having a boron nitride coating layer has high density, high saturation magnetization and good lubrication, it can be compression-molded to a dust core having high density, high permeability, excellent DC superimposition characteristics and low loss.

1. A composite, soft-magnetic powder comprising soft-magnetic, iron-based core particles having an average particle size of 2-100 μm, and boron nitride-based coating layers each covering at least part of each soft-magnetic, iron-based core particle,
said coating layers being polycrystalline layers comprising fine boron nitride crystal grains having different crystal orientations and an average crystal grain size of 3-15 nm, the average thickness of said polycrystalline layers being 6.6% or less of the average particle size of said soft-magnetic, iron-based core particles.

2. The composite, soft-magnetic powder according to claim 1, wherein said soft-magnetic, iron-based core particles are made of pure iron or an iron-based alloy.

3. The composite, soft-magnetic powder according to claim 1, wherein the ratio of Fe on the outermost surface is 12 atomic % or less.

4. The composite, soft-magnetic powder according to claim 1, wherein the volume ratio of pure iron or an iron alloy is 70% or more.

5. A method for producing the composite, soft-magnetic powder recited in claim 1, comprising the steps of (1) mixing iron nitride powder having an average particle size of 2-100 μm with boron powder having an average particle size of 0.1-10 μm, (2) heat-treating the resultant mixed powder at a temperature of 600-850° C. in a nitrogen atmosphere, and (3) removing non-magnetic components.

6. The method for producing a composite, soft-magnetic powder according to claim 5, wherein an atomic ratio of said iron nitride powder to said boron powder is B/Fe≧0.03.

7. The method for producing a composite, soft-magnetic powder according to claim 5, wherein the heat treatment temperature is 650-800° C.

8. The method for producing a composite, soft-magnetic powder according to claim 7, wherein the heat the treatment temperature is 700-800° C.

9. A dust core formed by a composite, soft-magnetic powder, said composite, soft-magnetic powder comprising soft-magnetic, iron-based core particles having an average particle size of 2-100 μm, and boron nitride-based coating layers each covering at least part of each soft-magnetic, iron-based core particle; said coating layers being polycrystalline layers comprising fine boron nitride crystal grains having different crystal orientations and an average crystal grain size of 3-15 nm; the average thickness of said polycrystalline layers being 6.6% or less of the average particle size of said soft-magnetic, iron-based core particles.

10. The dust core according to claim 9, wherein said soft-magnetic, iron-based core particles are made of pure iron or an iron-based alloy.

11. The dust core according to claim 9, which has a density of 5-7 Mg/m³, and core loss of 528 kW/m³ or less at a frequency of 50 kHz and an exciting magnetic flux density of 50 mT, the change rate of said core loss per density change [(kW/m³)/(Mg/m³)] being −96 or more.

12. The composite, soft-magnetic powder according to claim 2, wherein the volume ratio of pure iron or an iron alloy is 70% or more.

13. The composite, soft-magnetic powder according to claim 3, wherein the volume ratio of pure iron or an iron alloy is 70% or more.

14. The method for producing a composite, soft-magnetic powder according to claim 5, wherein said soft-magnetic, iron-based core particles are made of pure iron or an iron-based alloy.

15. The method for producing a composite, soft-magnetic powder according to claim 5, wherein the ratio of Fe on the outermost surface is 12 atomic % or less.

16. The method for producing a composite, soft-magnetic powder according to claim 5, wherein the volume ratio of pure iron or an iron alloy is 70% or more.
